(19) United States
(12) Patent Application Publication
(10) Pub. No.: US 2005/0254716 A1
(43) Pub. Date: Nov. 17, 2005

(54) Method for compressing workload of digital-animation calculation

(75) Inventor: De-Yu Kao, Taipei (TW)

Correspondence Address: BACON & THOMAS, PLLC, 625 SLATERS LANE, FOURTH FLOOR, ALEXANDRIA, VA, 22314, US

(73) Assignee: Princeton Technology Corporation, Taipei County (TW)

(21) Appl. No.: 10/842,457

(22) Filed: May 11, 2004

(51) Int. Cl. G06K 9/36

(52) U.S. Cl. 382/236

(57) ABSTRACT

The present invention provides a method for compressing workload of digital-animation calculation. The method is to calculate by dividing the frame of the digital-animation into small blocks less than 16×16 pixels, and RAM is used to temporarily save the calculation results, and the calculation results can be used repeatedly, so as to reduce the workload of digital-animation calculation.

### BACKGROUND OF THE INVENTION

1. Field of the Invention

The present invention relates to a method for compressing workload of digital-animation calculation, and more particularly to a method that can calculate by dividing the frame of the digital-animation into small blocks less than 16 x 16 pixels, and RAM is used to temporarily save the calculation results, and the calculation results can be used repeatedly, so as to reduce the workload of digital-animation calculation.

2. Description of the Prior Arts

As to the digital-animation processing on the screens of computer, TV, mobile phone and the like, technologies for digital-animation compression have been used to reduce the memory space or the transmission bandwidth. The digital-animation compression technology has multiple formats, including MPEG-2, MPEG-4, AVS and H.264, all these formats use “motion estimation” to compress data. Normally, a consecutive animation should be played 20-30 frames per second so as to keep the frames running smoothly and easily, and the motion relationship between two consecutive frames must be determined by motion estimation.

One of the motion estimation methods is to divide the frame into MBs (Macro-block) of 16×16=256 pixels, and then to find out an optimal motion vector that is related to the previous frame for each of the MBs. With reference to FIG. 1, wherein frame A and frame B are two consecutive frames, however, when transmitting (or saving) the frame B, only the motion vector (indicated by the dotted arrow) of the train needs to be transmitted, and then the frame B is generated just by adding the background covered by the train in frame A and cooperating with the stored data of the train and the background. This methods is able to substantially reduce the transmission bandwidth (or reduce the volume of memory), however, it also increases the complexity of the calculation.

When calculating the motion vector of a certain MB in frame A, it must subtract the respective pixels of the certain MB in frame A by the corresponding pixels of a certain MB in frame B (full search), and then add the 256 absolute differences together so as to get a “sum of absolute differences (SAD). In this case, many SADs are produced when calculating all the MBs in frame B, and the location of a comparative point corresponding to a minimum SAD is the target point. A location difference of the target point relative to the comparative point in frame A is the so-called “motion vector”. To reduce the calculation workload, initially a small searching range is defined and if the SAD found in the small searching range is less than a preset value, then the location difference to the comparative point is the so-called motion vector.

Referring to FIG. 2, based on the full search of motion estimation and the searching range is 32×32 pixels, the size of MB is 16×16, if we want to find a motion vector of a certain MB, the certain MB and all the other MBs should be calculated, thus there will be 17×17=289 MB comparisons (MB is only allowed to move in a range of 17×17). Each comparison is processed based on the method of “minimum sum of absolute differences” (MAD). Initially a pixel value of a MB is subtracted by a corresponding pixel value of another MB and then to get the absolute value, then get the sum of the absolute value, which totally needs 767 operations (subtraction 256, getting absolute value 256, summation 255, 256+256+255=767). There are 289 MB comparisons, each comparison needs 767 operations, thereby it totally needs 289×767=221,663 operations to find a motion vector of a MB. And each of the other neighboring MBs also needs 221,663 operations.

If a frame has 720×480 pixels, which can be divided into 1350 NMBs, the respective MBs are closely adjacent to each other without overlap, the searching ranges of the respective MBs are overlapped. However, each of the respective MBs needs to be re-calculated. In this case, it totally needs 2.99×10⁸ (1350×221663) operations to finish the motion vectors calculation of this frame. A consecutive animation is usually played at 22 frames/second, thereby the total operation rate is about 6.58×10⁹ operations/second (22×2.99×10⁸).

Thereby, the full-search calculation is too complicated, and the system should be equipped with high system clock and large DSP, accordingly the power consumption is high and the battery of portable electronic instruments is unable to support the load, and the cost is increased. Thus, many new solutions have been developed and which are divided into two categories: first, to reduce the number of the comparative points, second, to reduce the operations. Both solutions can be used at the same time so as to reduce the calculation workload to the least.

Many solutions can be used to reduce the comparative points, including “three-step search” (TSS), “four step search” (FSS), etc, which are used to find several points in a preset searching range and figure out the minimum MAD value, and then process a region calculation around the minimum MAD.

Solutions used to reduce the operations are relatively few. Inequality shown as below is one of them.
SUM(ABS(a−b))>=ABS(SUM(a)−SUM(b))

Wherein a and b represent the pixel value of the respective points of two MBs. The meaning of this inequality is that the sum of absolute difference between the corresponding pixel value of two MBs (MAD calculation) is greater than or equal to the absolute difference between the respective sum of the pixel value of the two MBs (it is called rough calculation).

By taking advantage of the characteristic of this inequality, we can take an arbitrary point in the searching range as a first comparative point and perform a MAD calculation (that is the left side calculation of the above-mentioned inequality), this MAD value is taken as a “temporary minimum reference value”, then choose a second point to perform a calculation of the right side of the inequality (rough calculation). If the temporary minimum reference value is the real minimum value in the searching range, the MAD value of the second point should be greater than the temporary minimum reference value. However, if the rough calculation value of the second point is already greater than the temporary minimum reference value, according to the inequality, since the MAD value of the second point is greater than or equal to the rough calculation value of the second point, then it must be greater than the temporary minimum reference value, thereby, the temporary minimum reference value can be retained. If the rough calculation value is minor than the temporary minimum reference value, it is uncertain that the MAD value of the second point is minor than the temporary minimum reference value, in this case, the MAD calculation of the second point must be performed (the calculation at the left side of the above-mentioned inequality) and then to be compared with the temporary minimum reference value. If the MAD value of the second point is truly minor than the temporary minimum reference value, the MAD value of the second point will be taken as a new temporary minimum reference value.

Repeat the above-mentioned procedure until the comparisons of the 289 points in the searching range are finished, at each time of comparison the temporary minimum reference value will be registered in memory.

Referring to FIG. 2, according to the above-mentioned inequality, if the searching range is 32×32 pixels, MB size is 16×16 and suppose the minimum value is the MAD value of a first point at the top left corner of the drawing. There are 289 comparative points (17×17) in the searching range, and the MAD calculation method of the first comparative point is based on full search, which needs 767 operations. And the rest 288 comparative points are calculated with the rough calculation method at right side of the above-mentioned inequality. In each comparison, 255 additions should be performed to obtain the value of the SUM(b), and a subtraction from the SUM(a), and obtain absolute value, thereby totally 257 operations are needed. The SUM(a) of the first comparative point (it needs 255 additions) also can be used on the rest 288 comparative points. In this case, if the MAD value of the first comparative point is the minimum value, then 75,326 operations should be performed in order to finish the comparisons in full search range (767 operations at the first comparative point, 255 operations for SUM(a) at the first point, each of the rest 288 comparative points needs 257 operations, and 288 comparisons to the temporary minimum reference value, 767+255+257×288+288=75,326), which is far less than 221,663.

The above-mentioned inequality can substantially reduce the calculation workload, however, we found it can be further improved.

The present invention has arisen to mitigate and/or obviate the afore-described disadvantages of the conventional calculation method for compressing workload of digital-animation calculation.

### SUMMARY OF THE INVENTION

The primary object of the present invention is to provide a calculation method for compressing workload of digital-animation calculation, which is used to divide the frame of digital-animation into small blocks whose size is less than 16×16 pixels, the sum of pixel value of the each small block is calculated respectively and stored in memory, and by taking advantage of the inequality that the sum of absolute difference between the corresponding pixel value of two MBs (MAD calculation) is greater than or equal to the absolute difference between the respective sum of the pixel value of the two MBs (rough calculation), the present invention is to figure out a MAD value of an arbitrary point in the searching range of MB, the MAD value is taken as a temporary minimum reference value and registered in memory, and then to find out the rough calculation values of the rest points in the searching range according to a small block per unit. If the rough calculation value is greater than or equal to the temporary minimum reference value, the temporary minimum reference value can be retained, otherwise the MAD value of the rest points should be calculated, if the MAD value of the rest points is greater than or equal to the temporary minimum reference value, the temporary minimum reference value will be retained, otherwise, the temporary minimum reference value will be replaced by the MAD value of other point.

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 shows the motion vector in accordance with the present invention;

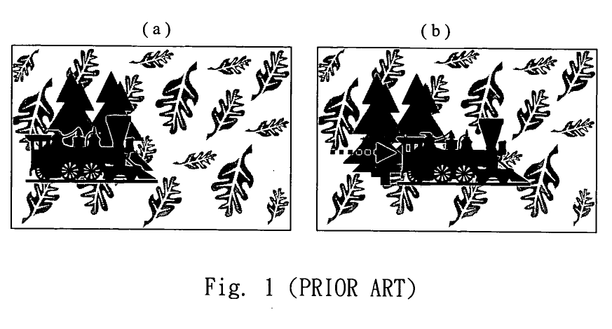

FIG. 2 is an illustrative diagram of the full search motion estimation in accordance with the present invention;

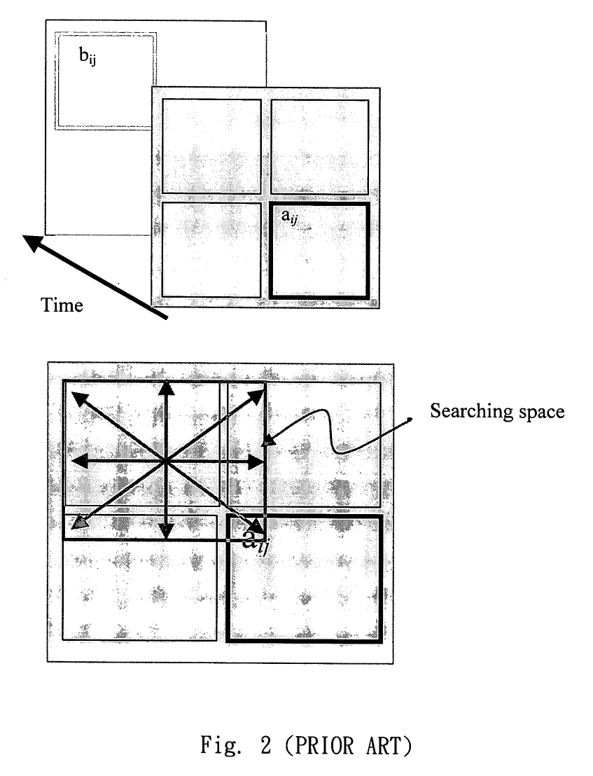

FIG. 3 shows the DSP/ALU in accordance with the present invention;

FIG. 4 is an illustrative diagram for showing the complexity of the first line of the full search motion estimation in accordance with the present invention;

FIG. 5 is an illustrative diagram for showing the complexity of the second line of the full search motion estimation in accordance with the present invention;

FIG. 6 is an illustrative diagram for showing the complexity of the third line of the full search motion estimation in accordance with the present invention.

### DETAILED DESCRIPTION OF THE PREFERRED EMBODIMENTS

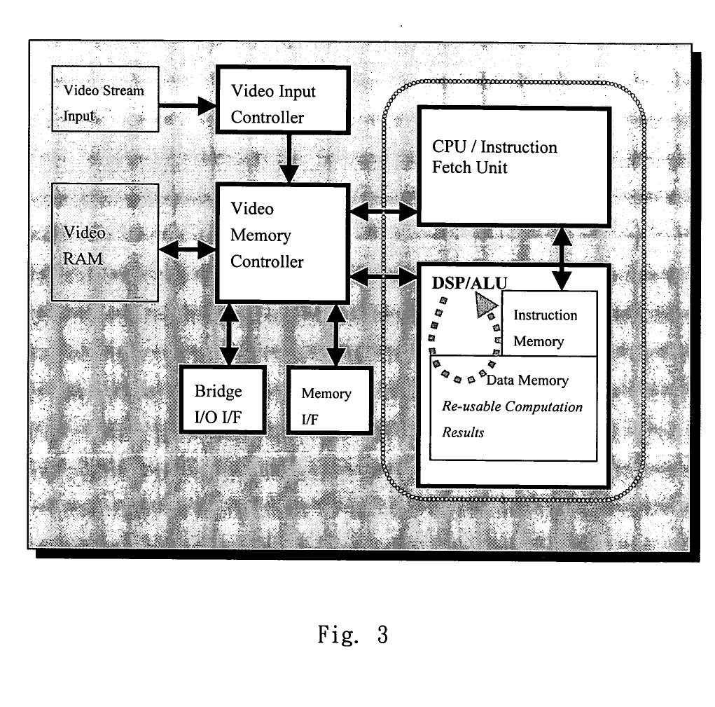

Referring to FIG. 3, which shows a system in accordance with the present invention employed to save the previous calculation results with a “Data Memory” (i.e. a RAM, wherein the RAM can be in form of DRAM or SRAM, etc), which is a mature digital integrated circuit, so there is no problem in production.

According to the full search of motion estimation, if searching range is 32×32 pixels and the size of MB is 16×16 pixels, it needs 221,663 operations to find out the motion vector for each MB. And it needs 75,326 operations by using the above-mentioned inequality method.

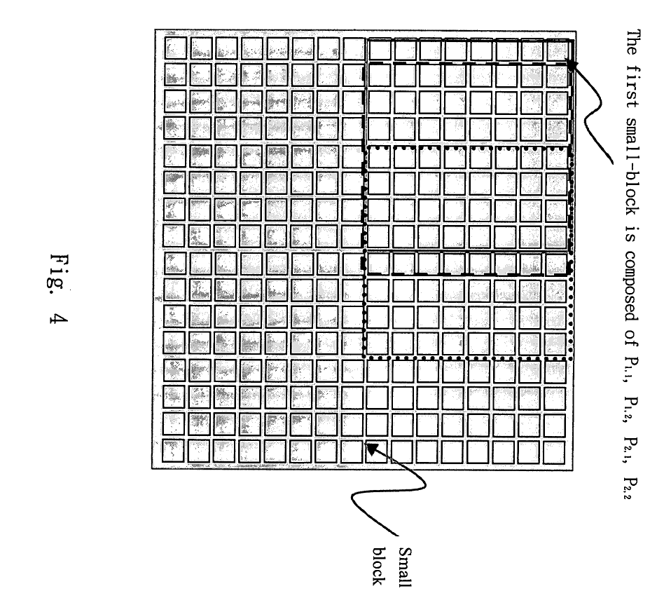

The calculation method in accordance with the present invention is shown in FIG. 4, all conditions are same as above, however, the searching range 32×32 pixels are partitioned into 256 small-blocks of 2×2 pixels.

Suppose that the first comparative point P_{1,1} at the upper left corner corresponds to a minimum value. It must use the MAD method when matching the first point with itself, so as to find out a “temporary minimum reference value” in this searching range, which needs 767 operations (16×16=256 subtractions, get the absolute value of 256 operations, 255 summations, 767=256+256+255, same as the above-mentioned full search method).

Comparisons between the point P_{1,1} and the respective points are performed based on the rough calculation at the right side of the above-mentioned inequality. The rough calculation is made according to a small block of 2×2 pixels per unit, and each small-block has 4 pixels, firstly it needs 3 operations to add the values of the 4 pixels together and the calculation results of each small-block are temporally stored in the Data Memory (RAM) of the DSP/ALU in FIG. 3, and then add the values of the 64 small-blocks in the 16×16 pixels of the MB together, which totally needs 255 operations (3 summations×64+63), so as to get the sum of the 64 small-blocks. It needs 255 operations for the point P_{1,1} to get the sum of the 64 small-blocks of its own by using the rough calculation, and then the result to be used later is stored in memory. It also needs 255 operations for each point to get the sum of the 64 small-blocks of the rest respective points (3 summations×64+63), and then subtract the sum of the 64 small-blocks of the point P_{1,1} by that of the rest points and get the absolute value, so as to obtain the rough calculation at the right side of the above-mentioned inequality.

Since the performances of load and store of the memory access are parallel processed with general operation instructions, it is temporally omitted from the following calculations.

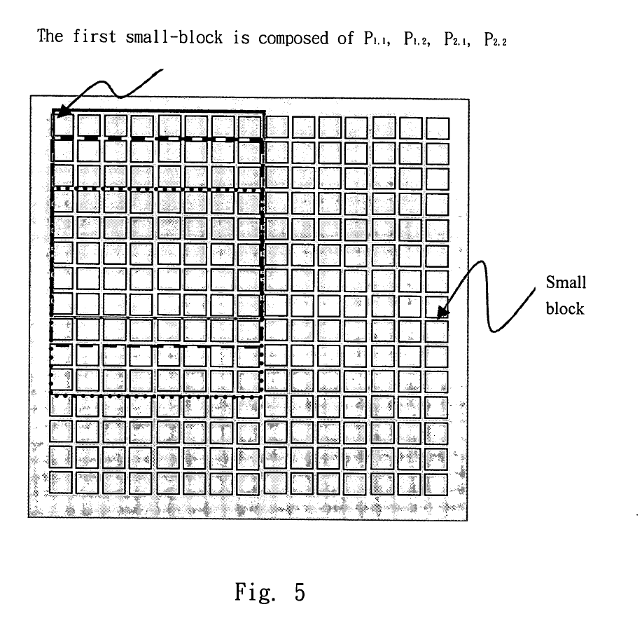

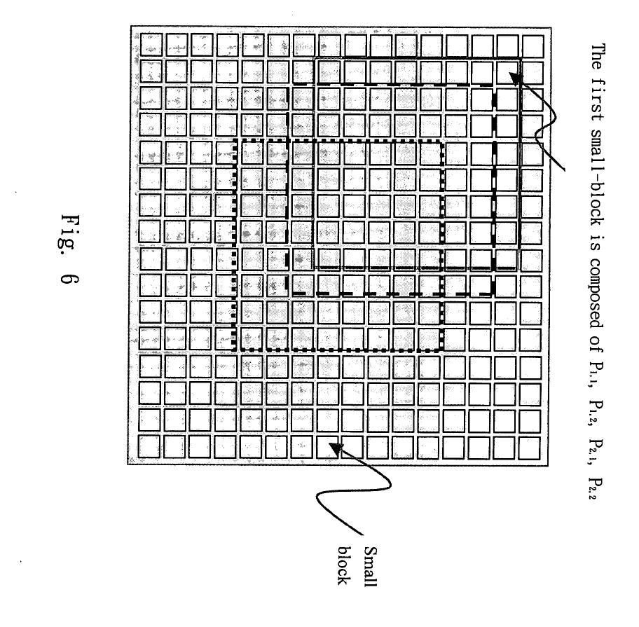

The first comparative point P_{1,1} takes about 255 operations (summations 3×64+63) to get the sum of the 64 small-blocks of its own, and the second comparative point P_{1,2} also needs 255 operations (3 summations×64+63) to get the sum of the 64 small-blocks of its own. However, the 3^{rd}, the 4^{th} . . . the 17^{th} comparative points P_{1,3}˜P_{1,17} in the first row, each of which only needs 87 operations (3×8+63) because only 8 new small-blocks need to be re-calculated and the values of the rest 56 small-blocks have been stored in memory during the calculation of the point P_{1,1}. The operations for calculating the sum of the comparative points (P_{2,1}˜P_{2,17}) in the second row are same as that of the first row (as shown in FIG. 5). The first and the second comparative points P_{3,1} and P_{3,2} in the third row (as shown in FIG. 6) only need 87 operations (3×8+63) because only 8 new small-blocks need to be re-calculated and the values of the rest 56 small-blocks have been stored in memory during the calculation of the points P_{1,1} and P_{1,2}. The 3^{rd}, the 4^{th} . . . the 17^{th} comparative points P_{1,3}˜P_{1,17} in the third row, each of which only needs 66 operations because only 1 new small-block needs to be calculated (3 additions+63 sumations of the results of the 64 small-blocks). The operations workload for the comparative points (P_{4,x}˜P_{17,x}) from the 4^{th} row to the 17^{th} row are same as that of the third row (as shown in FIG. 6).

The precise calculation (MAD) for a comparative point is performed only when the result of the rough calculation is minor than the “temporary minimum reference value”. If the result of the MAD is minor than the “temporary minimum reference value”, it will substitute the “temporary minimum reference value” and stored in memory. If the result of the rough calculation is greater than the “temporary minimum reference value”, obviously, this comparative point is not the target, and then the rough calculation for the next comparative point is performed. Repeat these procedures until all the calculations for the 289 comparative points have been done. (the possibly necessary MAD calculations have been omitted from the above calculations since the value of the first comparative point is supposed to be the optimum value, however, some methods have been found in real operation which can be used to effectively find the first comparative point, namely the optimum value, however, it will not be discussed in this present invention).

To summarize the above-mentioned methods, if searching range is 32×32, MB is 16×16, calculation workload will be 22,721 operations, wherein:
767 operations for the MAD calculation of the point P_{1,1}
255 operations for calculating the sum of the 64 small-blocks of the P_{1,1},
255+1+1+1 operations (subtract, get the absolute value and compare) for the comparison between the point P_{1,1} and the point P_{1,2}
255+1+1+1 operations the comparison between the point P_{1,1} and the point P_{2,1}
255+1+1+1 operations for the comparison between the point P_{1,1} and the point P_{2,2}
87+1+1+1 operations for each comparison between the point P_{1,1} and the respective points P_{1,3}˜P_{1,17}
87+1+1+1 operations f for each comparison between the point P_{1,1} and the respective points P_{2,3}˜P_{2,17}
87+1+1+1 operations for each comparison between the point P_{1,1} and the respective points P_{3,1}˜P_{17,1}
66+1+1+1 operations for each comparison between the point P_{1,1} and the rest points respectively
767+255×4+9+(90×15)×4+(69×15×15)=22721 operations

If a frame has 720×480 pixels, which can be divided into 1350 MBs, the respective MBs are adjacent to each other without overlap. However, the size of the MBs in the searching range of 32×32 is 16×16, there are a great of the searching range of the respective MBs and that of the neighboring MBs are overlapped, in this case, the calculation result of the small-blocks can be repeatedly used on the respective MBs. To finish the motion estimation of a frame, the total calculation workload is less than 3.07×10⁷ operations (1,350×22,721). If the running rate is at 22 frames per second, the calculation workload is less than 6.75×108 operations (3.07×107×22) per second. Thereby, the total calculation workload in accordance of the present invention is only 30.2% that of the inequality.

According to the specifications of the MPEG-2, the MPEG-4, the AVS and the H.264, all the MBs are closely adjacent to each other, therefore, the searching ranges of the respective MBs are overlapped. Use this feature wisely, when the resolution is increased, only the calculation workload for the top edge and the leftmost edge of a frame is relatively heavy, while each of the rest MBs only needs about 20,000 operations. Thereby, the calculation method in accordance with the present invention is capable of further reducing the calculation workload.

While we have shown and described various embodiments in accordance with the present invention, it should be clear to those skilled in the art that further embodiments may be made without departing from the scope of the present invention.

1. A method for compressing workload of digital-animation calculation, motion estimation must be used to determine a motion relationship between identical images in two consecutive digital-animation frames, each of the digital-animation frames are divided into MBs (Macro Block) of 16×16=256 pixel matrix, and a searching range larger than 16×16 pixel matrix is defined for each of the respective MBs, and then search in the searching range and find out an optimal motion vector related to next frame;
to reduce calculation workload, dividing the frame of digital-animation into small blocks whose size is less than 16×16 pixels, and then calculating a sum of pixel value of the respective small block respectively and the sum is stored in memory, by taking advantage of an inequality: sum of absolute difference between corresponding pixel values of two MBs (MAD calculation) is greater than or equal to absolute difference between the respective sum of the pixel value of the two MBs (rough calculation), to figure out a MAD value of an arbitrary point in the searching range of MB, the MAD value is taken as a temporary minimum reference value and registered in memory, and then to find out the rough calculation value of an other point in the searching range according to the sum of pixel value of the small block stored in memory, if the rough calculation value is greater than or equal to the temporary minimum reference value, the temporary minimum reference value will be retained, otherwise, the MAD value of the other point should be calculated, if the MAD value of the other point is greater than or equal to the temporary minimum reference value, the temporary minimum reference value will be retained, otherwise, the temporary minimum reference value will be replaced by the MAD value of the other point.

2. The method for compressing workload of digital-animation calculation as claimed in claim 1, wherein the small blocks are matrixes of 2×2 pixels.
